(19) United States
(12) Patent Application Publication
(10) Pub. No.: US 2009/0097629 A1
(43) Pub. Date: Apr. 16, 2009

(54) Identification of Original Destination of Forwarded Communications

(76) Inventors: Nicholas Steven Huslak, Johns Creek, GA (US); Edward M. Silver, Atlanta, GA (US); Terry Silver, Decatur, GA (US); Anita Hogans Simpson, Decatur, GA (US)

Correspondence Address: AT&T Legal Department - MB;Attn: Patent Docketing, Room 2A-207, One AT&T Way, Bedminster, NJ, 07921, US

(21) Appl. No.: 11/869,881

(22) Filed: Oct. 10, 2007

(51) Int. Cl. H04M 3/42; H04M 3/56

(52) U.S. Cl. 379/207.01; 379/211.02

(57) ABSTRACT

Methods, apparatus and computer program products are provided for re-forwarding a forwarded communication, such as a telephone call to a destination communication device, such as a telephone. Methods according to some embodiments include receiving the forwarded communication at a communication port, re-forwarding the forwarded communication to the destination communication device, generating an identification signal based on an identity of the communication port, and transmitting the identification signal to a user of the destination communication device.

### BACKGROUND

The present invention relates to communication processing. In particular, the present invention relates to methods, systems and computer program products for handling forwarded communications, such as telephone calls.

Call forwarding is a popular service provided to users of a telephone system in which a call to a destination number is redirected, or forwarded, to another telephone number. The service can be convenient for telephone customers who have several telephone numbers associated with different telephones, such as a home wireline telephone, a business wireline telephone number, a home mobile telephone, a business mobile telephone, etc. The user can forward calls incoming to one or more telephones to a single convenient telephone line. For example, a user may forward his or her home telephone and home mobile numbers to a business mobile telephone number, so that a call received at his or her home telephone or home mobile telephone number will be forwarded to his or her business mobile telephone number. Since the user may keep his or her business mobile telephone at hand and powered on during the day, the user can receive calls on his or her business mobile telephone that may otherwise be missed. Call forwarding services are commonly provided to users of many different types of telephone systems, including standard analog wireline telephone services, analog and digital cellular telephone services, and digital Voice over IP (VoIP) services, among others.

Caller identification (“Caller ID”) is another popular telephony service that is available to users of many different types of telephone systems. In a Caller ID service, the telephone number of the calling party is transmitted to the destination telephone. The telephone number of the calling party can be displayed at the destination telephone, so that the user of the telephone can decide whether or not to take the call, to forward the call to voicemail, and/or to take some other action relative to the incoming call. In analog and digital cellular telephone systems and in VoIP systems, the telephone number of the calling party can be provided to the destination telephone during call setup procedures. In a conventional analog telephone system, the telephone number of the calling party can be provided to the destination telephone using a modulated digital signal that is transmitted during rings. Typically, in order to take advantage of Caller ID services in a conventional analog telephone system, the destination telephone must be equipped with appropriate circuitry to decode and display the Caller ID information (i.e. the telephone number of the calling party), or else an add-on caller ID box must be connected to the telephone line to decode and display the Caller ID information.

In a telephone system, incoming calls may be handled a number of different ways, depending on the particular type of customer premises equipment (CPE) that is being used. For example, mid- to large-size enterprises may have one or more private branch exchanges (PBX) installed on premises that receive incoming calls and that provide such functions as interactive voice response (IVR), voicemail, and/or automatic call forwarding. In some cases, particularly for small companies and entities for which it is impractical to purchase and install a PBX, some PBX-like services may be provided at the switch level by a telephone company. Such services, which are typically referred to as Centrex-type services, may mimic the operation of a PBX, and may provide advanced call handling capabilities, IVR, voicemail, and other features without the necessity of installing expensive equipment at the customer's premises. Some advanced calling features, such as call forwarding, are provided by Advanced Intelligent Network (AIN) functionality that is included in some current telephone systems.

In addition to PBX and Centrex-based call handling, some advanced call handling functions may be provided by a Voice over IP (VoIP) internet telephony system. To utilize Internet telephony communications, a subscriber may obtain equipment, such as Integrated Access Devices (IADs), Analog Terminal Adapters (ATAs), telephone adapters (TAs) and the like, to be installed at the subscriber's premises, for example, a customer's home. The equipment is needed to support a voice path within the premises and through a broadband connection, for example, a digital subscriber line (DSL) connection, back to the customer's Internet Service Provider (ISP). Once the necessary equipment is installed, customers/subscribers can connect their existing analog phones, for example, Plain Old Telephone Service (POTS) phones, to the Analog Terminal Adaptors (ATAs) or telephone adapters (TAs) to originate and/or receive calls using Internet telephony, for example, over a VoIP line. A VoIP dial-tone is provided by the telephone adaptor (TA) to any phone extensions with ATAs connected. Incoming call processing may be performed at the customer premises and/or at a remote server with which the IAD communicates.

In addition to traditional PBX and Centrex-like services, VoIP systems provide users with certain functionality not typically available to users of traditional analog telephone services. For example, a user of a VoIP system may be able to customize incoming and outgoing call handling procedures, call preferences, call permissions, etc., using an IP interface to a feature server (application server). Call notifications may be provided to a user via instant messaging, and a user may be able to adjust call handling for an incoming call via an IP connection with the VoIP server without answering the call.

Accordingly, advanced call handling functionality such as call forwarding and caller ID are available to users of many different kinds of telephone services.

### SUMMARY

When a user has multiple communications devices set up to forward incoming calls to a single communications device and wants to be able to identify the original destination of the call, some embodiments provide methods of re-forwarding a forwarded communication to a destination communication device. The methods include receiving the forwarded communication at a communication port, re-forwarding the forwarded communication from the communication port to the destination communication device, generating an identification signal based on an identity of the communication port, and transmitting the identification signal to a user of the destination communication device.

The identification signal may describe a forwarding communication device from which the forwarded communication was initially forwarded to the communication port.

The methods may further include retrieving a database entry corresponding to the communication port and obtaining from the database entry a description of the communication device from which the communication was initially forwarded.

The identification signal may include a telephone number, SIP address and/or name of the communication device from which the communication was initially forwarded. The identification signal may identify a class of communication devices including the communication device from which the communication was initially forwarded.

The communication may be received at a forwarding agent, and the methods may further include establishing an ancillary communication path between the forwarding agent and the user of the destination communication device. Transmitting the identification signal to the user of the destination communication device may include transmitting the identification signal over the ancillary communication path.

The ancillary communication path may be established between the forwarding agent and the destination communication device. In some embodiments, the ancillary communication path may include a short message service (SMS) connection.

The ancillary communication path may include an in-band or out-of-band signaling path to the destination communication device, and/or an on-hook signaling path to the destination communication device. The identification signal may include an audible announcement to the destination communication device.

Establishing the ancillary communication path may include establishing a three-party call with an original calling party and the destination communication device, and transmitting the identification signal may include playing the audible announcement to the destination communication device over the three-party call.

The ancillary communication path may include a session initiation protocol (SIP) session. The identification signal may include a distinctive ring signal provided to the destination communication device.

A forwarding agent according to some embodiments includes a plurality of incoming communication ports. The forwarding agent is configured to receive a forwarded communication at an incoming communication port, to re-forward the forwarded communication to a destination communication device, to generate an identification signal based on the incoming communication port, and to transmit the identification signal to a user of the destination communication device.

The forwarding agent may be further configured to establish an ancillary communication path to the user of the destination communication device, and to transmit the identification signal over the ancillary communication path.

Some embodiments provide computer program products for re-forwarding a forwarded communication to a destination communication device. A computer program product according to some embodiments includes a computer readable storage medium having computer readable program code embodied in the medium. The computer readable program code may include computer readable program code configured to receive the forwarded communication at a communication port, computer readable program code configured to re-forward the forwarded communication from the communication port to the destination communication device, computer readable program code configured to generate an identification signal based on an identity of the communication port, and computer readable program code configured to transmit the identification signal to a user of the destination communication device.

It will be understood that the present invention may also be embodied as computer program products. Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagram illustrating systems and/or methods according to some embodiments.

FIG. 2 is a schematic illustration showing call forwarding from multiple telephones to a single telephone.

FIG. 3A is a schematic illustration showing call forwarding using a forwarding agent according to some embodiments.

FIG. 3B is a schematic illustration showing call forwarding from multiple telephones to a single telephone using a forwarding agent according to some embodiments.

FIGS. 4A and 4B are schematic block diagrams illustrating telephones configured according to some embodiments.

FIGS. 5 and 6 are schematic block diagrams illustrating systems and/or methods according to embodiments.

FIG. 7 is a flowchart illustrating operations according to embodiments.

### DETAILED DESCRIPTION OF EMBODIMENTS

Some embodiments provide apparatus and computer program products for re-forwarding to a destination telephone a forwarded telephone call received from a forwarding telephone, and notifying the user of the destination telephone of the identity of the telephone from which the call was originally forwarded.

Embodiments of the present invention now will be described more fully hereinafter with reference to the accompanying drawings, in which embodiments are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer usable program code embodied in the medium. Any suitable computer readable medium may be utilized including magnetic storage devices such as hard disks, optical storage devices such as CD ROMs, DVD-ROMs and the like, and semiconductor based storage devices such as flash memory.

The present invention is described below with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

As discussed above, advanced call handling functions, such as call forwarding and caller ID, may be provided using advanced intelligent network (AIN) enabled switches, PBX terminals, VoIP application servers and/or other types of telephone services. However, a potential problem can arise when a telephone number is forwarded to a destination number. Namely, under conventional call handling procedures, when a call is forwarded to a destination telephone, the caller ID presented to the destination telephone identifies the telephone number of the original calling party. If multiple telephones are forwarded to the same destination telephone number, the user of the destination telephone can see the telephone number of the original calling party, but does not know what telephone number (of the multiple telephones) the telephone call was forwarded from.

For example, if a user has his or her home and business wireline telephone numbers forwarded to a wireless telephone, when a telephone call is forwarded to the wireless telephone, the user can see the telephone number of the calling party using Caller ID, but may not know that the telephone call was forwarded or whether the telephone call was forwarded from his or her home wireline telephone number or from his or her business wireline telephone number.

Accordingly, embodiments provide systems and methods by which a user of a destination telephone to which multiple telephone numbers are forwarded can be informed of which of the multiple telephones an incoming call was forwarded from. Although embodiments are described below primarily in the context of telephony communications, including circuit-switched and packet-switched applications, the invention can be applied to many other different types of communications, communication networks and/or communication devices, and is not limited to telephony communications.

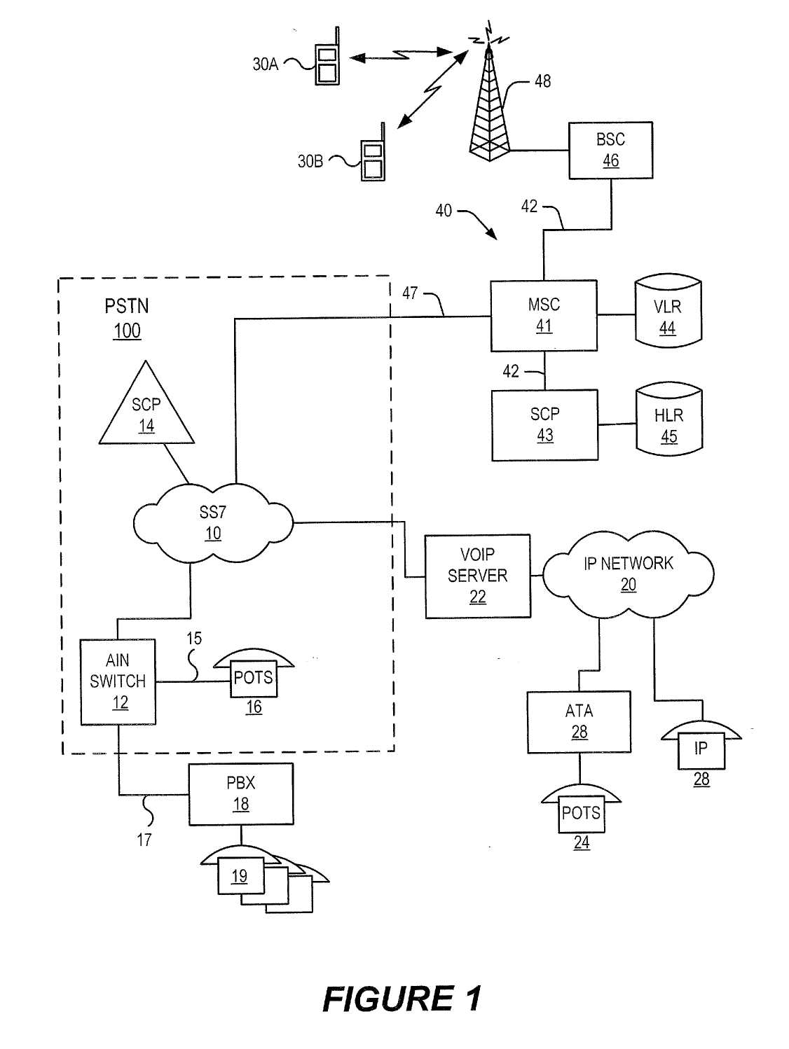

FIG. 1 is a schematic block diagram illustrating systems and/or methods according to embodiments. Referring to FIG. 1, a communication system in which embodiments may be implemented may include portions of a public switched telephone network (PSTN) 100. The PSTN 100 includes a service control point (SCP) 14 that communicates with a central office switch 12, for example through an SS7 signaling network 10. The central office switch 12 may in some embodiments be an advanced intelligent network (AIN) switch 12, that is capable of advanced call handling functions. The AIN switch 12 may in some embodiments be configured to provide Centrex services, such as incoming call handling services, to a communication device, such as an analog telephone 16 connected to the AIN switch 12 via a twisted-pair line 15.

In some cases, the customer premises equipment may include a PBX 18 connected to the AIN switch 12 or to a standard central office switch through a high capacity trunk 17. The PBX 18 may serve one or more communication devices, such as analog and or digital telephones 19. The PBX 18 may handle incoming call processing functions for the attached telephones 19.

Voice over IP (VoIP) services may also be provided in the network by a VoIP service provider that operates a VoIP server 22. The VoIP server 22 is connected to the SS7 signaling network 10 as well as to an IP network 20, such as the Internet. A communication device, such as an IP telephone 28 may communicate through the IP network 20 with the VoIP server 22. In addition, a standard analog telephone 24 may communicate with VoIP server 22 through the IP network 20 and an analog terminal adapter (ATA) 28.

Wireless communication devices, such as wireless telephones 30A, 30B communicate through a public wireless communication network 40, which may operate in accordance with a wireless communication standard, such as GSM (Global System for Mobile Communications). The wireless telephone network 40 can also include an IS-95 CDMA network, an IS-54 TDMA/FDMA network, an advanced mobile phone service (AMPS) network, a W-CDMA network, a cdma2000 network, or other conventional wireless network. The public wireless communications network 40 includes at least one service control point (SCP) 43 which manages a home location register (HLR) 45 for the network 40. The HLR 45 is a database that contains information, such as registration information, call settings, subscribed features, location information, directory information, identification information, and/or other information concerning wireless telephones that are subscribed to the network 40. The HLR 45 is also used to authenticate wireless telephones and to support mobility management features to which the user of a wireless telephone has subscribed when that user is roaming.

The HLR 45 may be implemented as a single database and/or may be distributed over a number of databases. The network 40 further includes one or more mobile switching centers (MSCs), such as MSC 41, which manage call setup and routing for wireless telephones within a geographic area served by the MSC. The MSC 41 is connected to the service control point 43 through a high speed communications link 42. The HLR 45 may also be connected directly to the MSC 41 without using a service control point. One or more base station controllers (BSC) 46 are connected to the MSC 41. Each BSC 46 manages at least one base station 48, which transmits/receives wireless communications signals to/from wireless telephones located within a geographic cell/sector served by the base station 48.

The MSC 41 is connected to the BSC 46 via a communications link 42 which includes signaling data links and trunk circuits to provide switching between the MSC 41 and other MSCs and/or networks. The MSC 41 coordinates the establishment of calls to and from mobile stations located within a geographic area served by the MSC 41. In particular, the MSC 41 is responsible for transmission facilities management (i.e. controlling the operation of BSCs 46), mobility management (controlling the handover of calls from one BSC 46 to another), and call processing. The MSC is also connected with the PSTN 100 by trunk circuits 47 to route calls to and from the PSTN 100 and other networks connected to the PSTN 100.

Each MSC has an associated visitor location register (VLR) 44, which contains a database with temporary information about wireless telephones that access a base station 48 served by the MSC 41. Information about a wireless telephone may be obtained by the HLR of the wireless telephone's home network and/or from the wireless telephone itself. When a wireless telephone 30B, 30A identifies itself to an MSC 41, the MSC 41 sends a registration notice to the HLR 45 of the home network of the wireless telephone 30A, 30B, via an IS-41/GSM MAP link to authenticate the wireless telephone 30A, 30B. The HLR of the wireless telephone 30A, 30B may be the HLR 45 of the network 40 to which the MSC 41 belongs, or it may be the HLR of a different network. In the present example, the wireless telephones 30, 30B are subscribed to the network 41, so the registration notice is sent from the MSC 41 to the HLR 45 of the wireless communications network 40. Once verified, the data for the wireless telephone 30A, 30B is transferred from the HLR 45 to the VLR 44 of the MSC 41. The VLR 44 maintains the record of the wireless telephone 30A, 30B while the wireless telephone 30A, 30B is active in a cell served by the MSC 41.

Accordingly, communications, such as telephone calls, can be established to/from any communication device in the systems shown in FIG. 1, including to/from one or more POTS telephones 16, PBX-attached telephones 19, VoIP-attached telephones 24, 28, and/or wireless telephones 30A, 30B. It will be appreciated that other telephones and/or telephone systems, such as long distance telephone systems, other wireless communication systems, etc., can be connected to the PSTN 100, the wireless communication system 40 and/or the IP network 20, and can establish communications with the communication devices therein. Furthermore, as discussed above, advanced call handling services, such as Call Forwarding and Caller ID, can be provided to any of the communication devices shown in FIG. 1 by their respective communication systems.

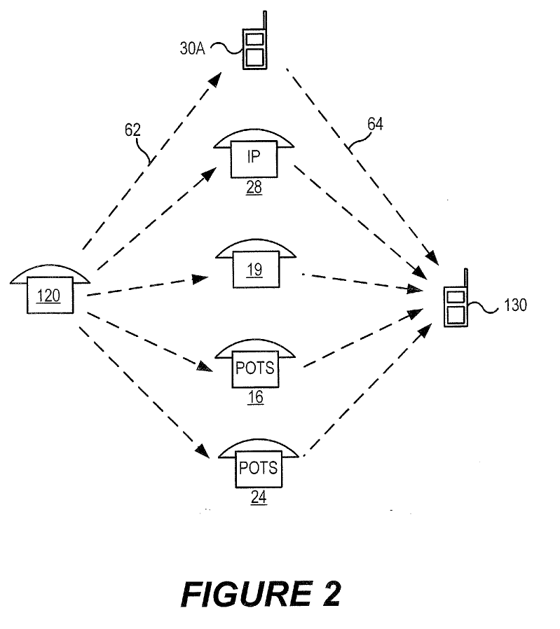

FIG. 2 illustrates a possible scenario in which multiple telephones are forwarded to single destination telephone number. For example, as illustrated in FIG. 2, calls to a number of telephones can be forwarded to a single destination telephone 130. Thus, calls incoming to a POTS telephone 16, a PBX-connected telephone 19, a VoIP telephone 24, 28, and/or a wireless telephone 30A can be forwarded to a single destination telephone 130. In the illustrated example, the destination telephone 130 is a wireless telephone, although the destination telephone can be a POTS telephone, a PBX-connected digital or analog telephone, a VoIP connected telephone, or any other type of telephone to which calls can be placed. Likewise, the originating telephone 120 can be a POTS telephone, a PBX-connected digital or analog telephone, a VoIP connected telephone, a wireless telephone, or any other type of telephone from which calls can be placed.

Telephone calls 62 that originate at the originating telephone 120 and that are originally destined for one of the forwarding telephones 16, 19, 24, 28, 30A, are received by the telephone systems of the respective forwarding telephones 16, 19, 24, 28, 30A, and are forwarded to a single destination telephone 130 as forwarded telephone calls 64. As noted above, when the forwarded call 64 is received by the destination telephone 130, the call setup information provided to the destination telephone 130 indicates the identity of the original calling telephone (telephone 120) rather than the identity of the forwarding telephone 16, 19, 24, 28, 30A from which the telephone call was forwarded. Thus, upon receipt of a forwarded call, the user of the destination telephone 130 may be informed of the telephone number of the originating telephone 120, but in general will not know which of the forwarding telephones 16, 19, 24, 28, 30A forwarded the telephone call.

In some cases, it may be useful for the user of the destination telephone 130 to know which of the forwarding telephones 16, 19, 24, 28, 30A originally forwarded the telephone call. For example, while the user of the destination telephone 130 can see the telephone number of the originating telephone 120, he or she may not recognize the telephone number. If the user knew that the call was originally destined for a business telephone, such as his or her business desktop telephone, the user may be more likely to want to answer the telephone call, since it may be a valuable business call. However, if the user knew that the call was originally destined for a personal wireless telephone or home telephone, the user may be more likely to let the telephone call be answered by voicemail.

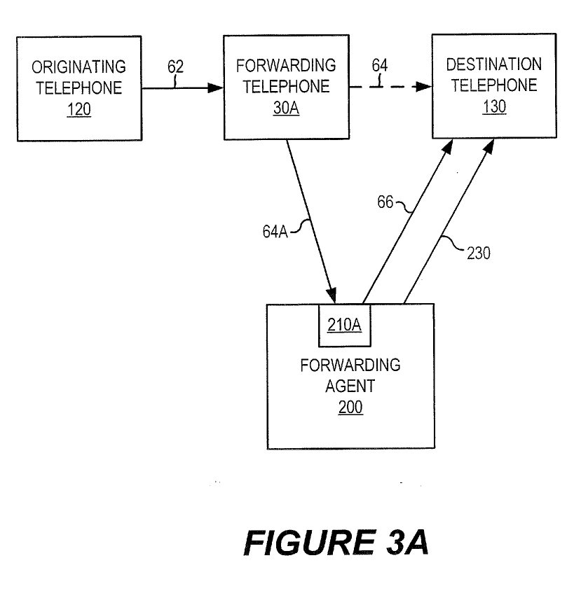

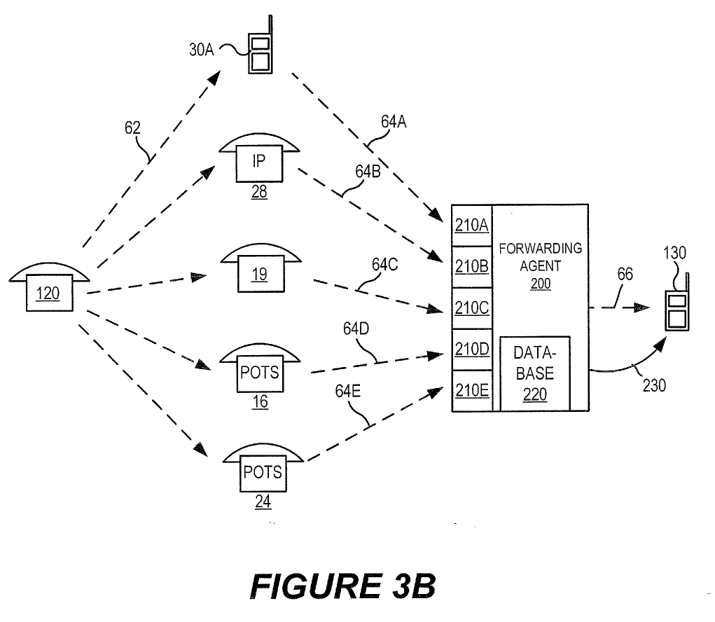

FIGS. 3A and 3B illustrate methods and/or systems according to some embodiments that can enable a user of a telephone to identify which of a number of forwarding telephones a telephone call was forwarded from. Referring to FIG. 3A, systems/methods according to embodiments include a forwarding agent 200. The forwarding agent 200 includes or is associated with a number of incoming telephone ports 210A-210E (FIG. 3B). That is, the forwarding agent 200 can receive and process calls over a plurality of ports 210A-210E, each of which may be associated with a respective identifier (e.g., telephone number, SIP address, etc.). In general, the identifiers used in various types of calling scenarios may not always be E. 164 (POTS) telephone numbers. For example, for VoIP/SIP calls, the SIP uniform resource identifier (URI) may be used as the identifier.

When the originating telephone 120 places a call to a forwarding telephone 30A, the forwarding telephone 30A can forward the telephone call to the forwarding agent 200 (arrow 64A) instead of forwarding the call to the destination telephone 130 (arrow 64). An incoming forwarded call 64A received at an incoming telephone port 210A of the forwarding agent 200 can be forwarded as a forwarded call 66 to the destination telephone 130.

Referring to FIG. 3B, many forwarding telephones can be configured to forward incoming calls to one of the telephone ports 210A-210E associated with the forwarding agent 200. In some embodiments, telephone calls from a particular forwarding telephone 16, 19, 24, 28, 30A can be forwarded to a respective telephone port 210A-210E associated with the forwarding agent 200 as forwarded calls 64A-64E. For example, calls incoming to the wireless telephone 30A may be forwarded to the telephone number associated with the first port 210A, calls incoming to the IP telephone 28 can be forwarded to the telephone number associated with the second port 210B, etc. The incoming call 64A-64E received at the forwarding agent 200 can then be forwarded by the forwarding agent 200 to the destination telephone 130 as a forwarded call 66.

When the call is forwarded to the destination telephone 130, the forwarding agent 200 notifies the user of the destination telephone 130 of the identity of the telephone 16, 19, 24, 28, 30A from which the call was forwarded by means of an ancillary communication path 230. For example, if a telephone call 64A is received on the first port 210A from the wireless telephone 30A, the forwarding agent 200 will forward the call to the destination telephone 130 as a forwarded call 66. The forwarding agent 200 also checks a database 220, such as a reference table, to determine the identity of the telephone or class of telephones configured to forward calls to the first port 210A. In the illustrated example, the wireless telephone 30A is configured to forward calls to the first port 210A. The forwarding agent 200 then notifies the user of the destination telephone 130 that the incoming call is being forwarded from the wireless telephone 30A, by transmitting a message to the user of the wireless telephone 30B using the ancillary communication path 230. For example, the message from the forwarding agent could identify telephone 30A by a handle stored in the database 220, such as its telephone number and/or a name, such as “Personal Mobile.”

The database can have a table structure, such as shown in Table 1.

TABLE 1
Agent Port/Subscriber Telephone No. Associations

| | Agent | | | |
|---|---|---|---|---|
| | Port | | Forwarding | |
| Agent | Telephone | Forwarding | Device | Destination |
| Port ID | Number | Device ID | Description | Telephone No. |
| 210A | 404-555- | 404-555-2378 | Personal Mobile | 404-555-9999 |
| | 1111 | | | |
| 210B | 404-555- | 404-555-3876 | Home | 404-555-9999 |
| | 1112 | | | |
| 210C | 404-555- | 404-555-2765 | Business Desk | 404-555-9999 |
| | 1113 | | | |

Accordingly, each port 210A-210E in the forwarding agent 200 may have an associated ID and telephone number. Furthermore, the table in the database 220 is configured to associate a forwarding ID, such as a forwarding telephone number and/or forwarding telephone name with a particular port associated with the forwarding agent 200. Finally, each port is associated with a destination telephone number to which calls into the port will be forwarded. In some embodiments, multiple telephone numbers can be assigned to a single port.

It will be appreciated that more than one forwarding telephone can be associated with a particular port of the forwarding agent 200. For example, a user may choose to forward all personal telephones to one port in the forwarding agent 200 and all business telephones to a second port in the forwarding agent 200. In that case, the database 220 may have the form shown in Table 2 below, wherein port telephone numbers are associated with one or more classes of forwarding telephones (e.g., Personal Telephones, Business Telephones, etc.).

TABLE 2
Port/Class Associations for Classes of Forwarding Telephones

| | Port Telephone | Forwarding Device | Destination |
|---|---|---|---|
| Port ID | Number | Class | Telephone No. |
| 210A | 404-555-1111 | Personal Telephones | 404-555-9999 |
| 210B | 404-555-1112 | Business Telephones | 404-555-9999 |

Thus, when a call is received at port 210A, the call is forwarded on to the destination telephone 130, and the user of the destination telephone 130 is notified that the call was forwarded from a “Personal Telephone.” When a call is received at port 21 B, the call is forwarded on to the destination telephone 130, and the user of the destination telephone 130 is notified that the call was forwarded from a “Business Telephone.” Although the user of the destination telephone 130 may not know which particular telephone the call was forwarded from, the user is provided with additional information about the original destination of the telephone call that can assist the user in deciding how to handle the call, e.g., whether or not to answer the call, let it roll over to voicemail, etc.

In some embodiments, a port 210 can be shared by multiple subscribers. For a port that is assigned to multiple subscribers, the Forwarding Device ID and Port ID can be used to retrieve the destination ID. Thus, for example, a shown in Table 3, when a call is received at a port (e.g. Port 210A), the forwarding agent checks the telephone number of the forwarding telephone and retrieves a database record corresponding to the forwarding telephone number. The call is then forwarded to a destination device based on the database record.

TABLE 3
Agent Port/Subscriber Telephone No. Associations

| | | | Forwarding | |
|---|---|---|---|---|
| Agent | Forwarding | | Device | Destination |
| Port ID | Device ID | User | Description | ID |
| 210A | 404-555-2378 | User A | Personal Mobile | 404-555-9999 |
| 210A | 404-555-3876 | User A | Home | 404-555-9999 |
| 210A | 404-555-2765 | User B | Business Desk | 404-555-8888 |

The ancillary communication path 230 can be established in a number of different ways, depending on user preferences, the type of destination telephone 130 being used, and/or the location/implementation of the forwarding agent 200. For example, if the destination telephone 130 is a wireless telephone that has short message service (SMS) capability, the ancillary communication path 230 could take the form of an SMS message to the destination telephone 130 informing the user of the destination telephone 130 of the identity of the forwarding telephone. Alternatively, the forwarding agent 200 could be configured to send an SMS message to another wireless device associated with the user, such as an interactive pager. Thus, when a call is forwarded to the destination telephone 130, an SMS message could be sent to the user's pager informing the user of the identity of the forwarding telephone.

The ancillary communication path 230 could also be established by in-band or out-of-band signaling to the destination telephone 130. For example, if the forwarding agent 200 is implemented in an intelligent network switch or PBX to which the destination telephone 130 is connected, the switch could signal the identity of the forwarding telephone to the destination telephone by sending an in-band signal between rings, similar to Caller ID signaling. On-hook signaling, such as the signaling used for “message waiting” indicators, can also be used. Alternatively, an out-of-band signal could be provided from the forwarding agent 200 to the destination telephone 130 to identify the forwarding telephone.

Similarly, when the forwarding agent 200 is implemented in an intelligent network switch or a PBX, the identity of the forwarding telephone could be signaled by sending a distinctive ring signal to the destination telephone 130.

In some embodiments, the ancillary communication path 230 could include audible communications to the destination telephone 130. For example, in some embodiments, the forwarding agent 200 could establish a call to the destination telephone 130 using a three-way calling feature, so that a three-way call is established between the originating telephone 120, the forwarding agent 200 and the destination telephone 130. When the call is answered at the destination telephone 130, the forwarding agent 200 could play an audible notification identifying the forwarding telephone to the destination telephone 130 over the voice path and then connect the forwarding telephone to the destination telephone before exiting.

In still further embodiments, such as when the destination telephone is a VoIP-connected telephone, the forwarding agent can establish an ancillary communication path 230 using session initiation protocol (SIP) messaging. SIP is an application-layer signaling protocol that can be used to establish communication sessions over IP networks. Upon receipt of a forwarded call, the forwarding agent 200 can establish a SIP session with the destination telephone or an ATA associated with the destination telephone and send a SIP message identifying the forwarding telephone.

In any case, if there is a time lag required to notify the destination telephone 130 of the identity of the forwarding telephone, the forwarding agent 200 can play a notification or other announcement to the originating telephone while the ancillary communication path 230 is being established.

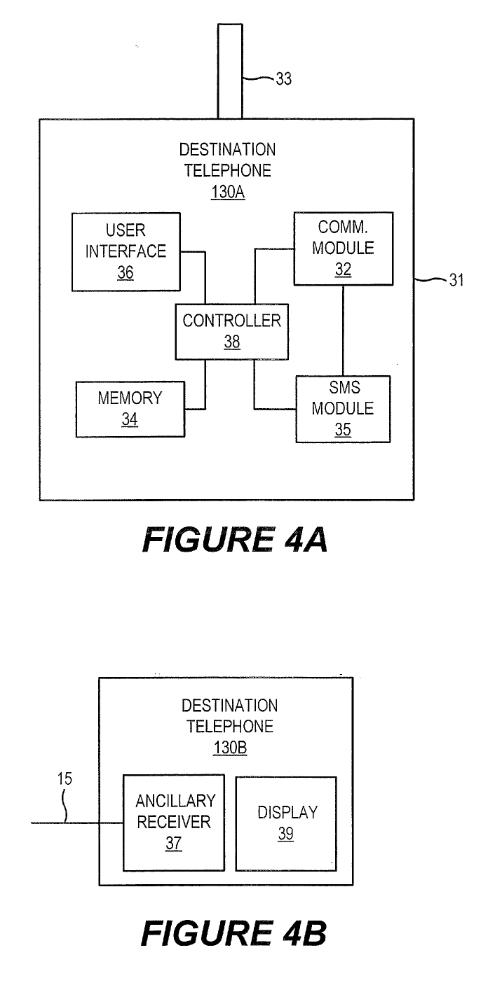

Referring now to FIG. 4A, an exemplary destination device 130A that is a mobile wireless telephone in accordance with some embodiments of the present invention is illustrated. The destination device 130A may be a mobile radiotelephone forming a part of a radiotelephone communication system 40 as illustrated in FIG. 1.

The destination device 130A in the illustrated embodiments includes a portable housing assembly 31, a controller 38, a communication module 32, an SMS module 35 and a memory 34. The wireless device 130A further includes a user interface 36 (i.e., a man machine interface) that can include a display, a speaker (i.e., a sound transducer), and at least one input device.

The user interface 36 may include any suitable input device(s) including, for example, a touch activated or touch sensitive device (e.g., a touch screen), a joystick, a keyboard/keypad, a dial, a directional key or keys, and/or a pointing device (such as a mouse, trackball, touch pad, etc.). The user interface 36 can also include a microphone coupled to an audio processor that is configured to generate an audio data stream responsive to sound incident on the microphone.

The controller 38 may support various functions of the destination telephone 130. The controller 38 can be any commercially available or custom microprocessor, for example. In use, the controller 38 of the destination device 130A may generate a display image on a display screen of the user interface 36. In some embodiments, however, a separate signal processor and/or video chip (not shown) may be provided in the destination device 130A and may be configured to generate a display image on the display.

The memory 34 is configured to store digital information signals and data such as a digital multimedia files (e.g., digital audio, image and/or video files).

The communication module 32 is configured to communicate data over one or more wireless interfaces to another wireless terminal and/or base station. The communication module 32 can include, for example, a cellular communication module, a direct point-to-point connection module, and/or a WLAN module.

With a cellular communication module, the destination device 1 30A can communicate via the base station(s) of the wireless network 40 (FIG. 1) using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS).

With a wireless local area network (WLAN) module, the destination device 130A can communicate through a WLAN using a communication protocol that may include, but is not limited to, 802.11a, 802.11b, 802.11e, 802.11g, and/or 802.11i.

The communication module 32 can include a transceiver typically having a transmitter circuit and a receiver circuit, which respectively transmit outgoing radio frequency signals (e.g., to the network 40, a router or directly to another terminal) and receive incoming radio frequency signals (e.g., from the network 40, a router or directly to another terminal), such as voice and data signals, via an antenna 33. The communication module 32 may include a short range transmitter and receiver, such as a Bluetooth transmitter and receiver. The antenna 33 may be an embedded antenna, a retractable antenna or any antenna known to those having skill in the art without departing from the scope of the present invention. The radio frequency signals transmitted between the destination telephone 130A and the network 40, router or other terminal may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

Accordingly, an ancillary communication path 230 can be established to the destination device 130A by any number of means, including an SMS connection, a CDPD connection, and/or a wireless IP connection to the destination terminal 30.

However, as discussed above, the destination device 130A may not need to have such sophisticated wireless communication capabilities in order to support the formation of an ancillary communication path 230. For example, referring to FIG. 4B, a destination device 130B could include a standard analog telephone with an additional ancillary receiver 37 connected to the twisted pair signal line 15. The ancillary receiver 37 could include an in-band receiver configured to decode in-band signals sent by the forwarding agent 200, such as audio frequency signals sent between rings. In other embodiments, the ancillary receiver 37 could include an out-of-band receiver configured to receive modulated communication signals transmitted by the forwarding agent 200 out of the voice band. In either case, the signals sent by the forwarding agent 200 are received by the ancillary receiver and decoded to obtain the identity of the forwarding telephone. The identity of the forwarding telephone can then be displayed on a display 39 in the destination device 130B.

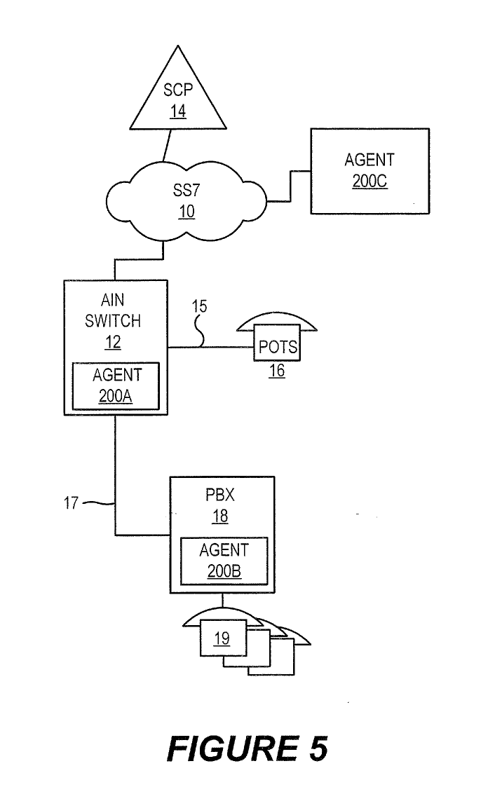

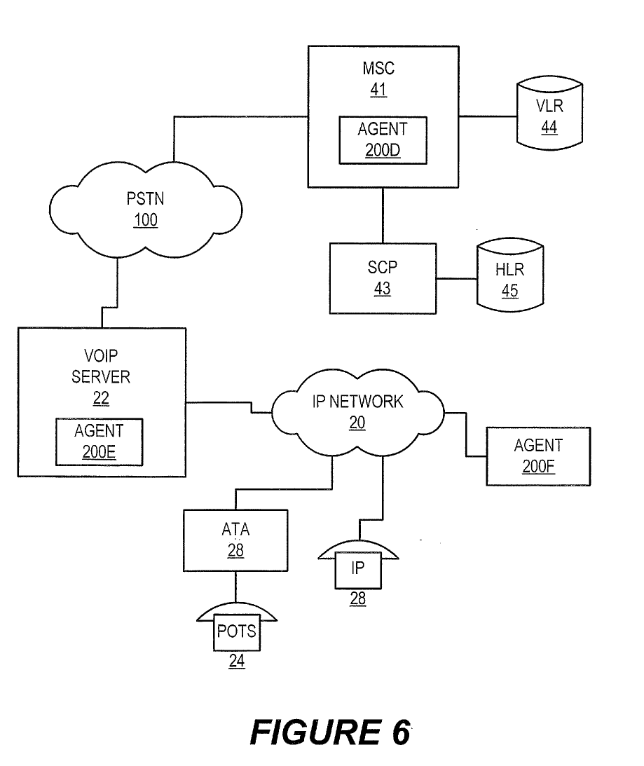

Referring again to FIGS. 5 and 6, the forwarding agent 200 can be implemented as hardware and/or software in a number of locations. For example, a forwarding agent 200A could be implemented as a software, hardware and/or firmware module in an intelligent network switch, such as the AIN switch 12. In the AIN switch 12, the forwarding agent 200A could be easily implemented using ring master numbers, which are multiple numbers assigned to a single POTS telephone.

A forwarding agent 200B could also be implemented as a software, hardware and/or firmware module in a PBX, such as the PBX 18. As further illustrated in FIG. 5, a forwarding agent 200C could be implemented in a standalone device within the PSTN 100.

As shown in FIG. 6, a forwarding agent 200D can be implemented in an MSC 41 of a wireless communication system 40. Similarly, a forwarding agent 200E can be implemented as a software, hardware and/or firmware module in a VoIP server 22, and/or a forwarding agent 200F could be implemented in a standalone server, e.g. in a VoIP feature or application server, connected to an IP network and served by a VOIP server 22 that is connected to the PSTN 100.

The location of the forwarding agent 200 can affect the means by which the ancillary communication path 230 can be established with the destination telephone. The location and type of destination telephone can also affect the kinds of ancillary communication paths can be used. For example, if the forwarding agent 200 is implemented in an AIN switch 12 or PBX 18 (FIG. 5) to which the destination telephone is connected, then the ancillary communication path 230 could be established using in-band or out-of-band signaling over the signal lines (e.g. copper twisted pair) connected to the destination telephone. However, if the destination telephone is a conventional analog telephone connected to a network switch and the forwarding agent 200 is not implemented in the switch (for example, if the forwarding agent 200 is implemented in a mobile switching center 41 or in a VoIP server 22), then the ancillary communication path 230 may be limited to providing an audible notification on the voice path when the call from the forwarding agent 200 to the destination telephone is established.

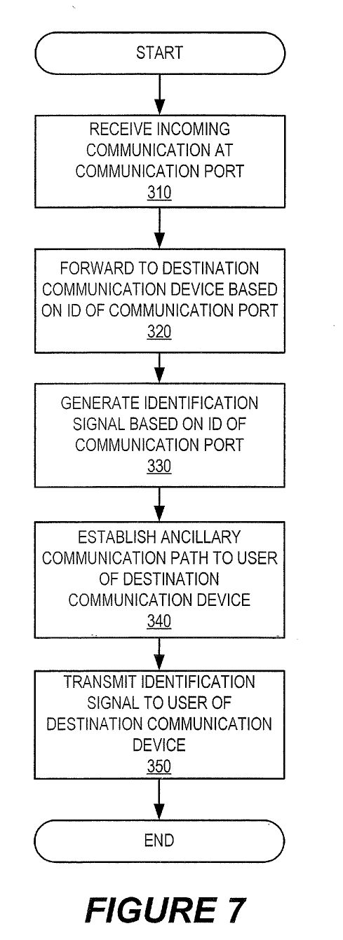

Methods according to embodiments are illustrated in FIG. 7, which is a flowchart of operations that may be performed by a forwarding agent according to some embodiments. Referring to FIGS. 3 and 7, an incoming communication is received at a communication port 210A of a forwarding agent 200 (Block 310). One or more communication ports, including the communication port 210A at which the call was received may be associated at the forwarding agent 200 with a particular destination communication device. That is, the forwarding agent is configured to forward communications received at the communication port 210A to the destination communication device. Accordingly, upon receipt of the communication at the communication port 210A, the call is forwarded to the destination communication device 130 based on the identity of the communication port 210A at which the call was received (Block 320).

Furthermore, based on the identity of the communication port 210A at which the communication was received, the forwarding agent generates an identification signal (Block 330). The forwarding agent establishes an ancillary communication path 230 to the user of the destination communication device (Block 340) and transmits the identification signal to a user of the destination communication device over an ancillary communication path 230 (Block 350). As noted above, the type of ancillary communication path 230 that may be established and the form of the identification signal may depend on where the forwarding agent is located in the network relative to the destination communication device and/or on the type and/or communication capabilities of the destination communication device.

The ancillary communication path can take many forms, and may include, for example, a short message service (SMS) connection and/or a session initiation protocol (SIP) session. The ancillary communication path may further include an in-band or out-of-band signaling path to the destination telephone.

The identification signal can include an audible announcement to the destination telephone. For example, in some embodiments, the ancillary communication path may include a three-party call with the destination terminal so that a three-way call is established between the originating telephone, the forwarding agent and the destination telephone, and the forwarding agent may be configured to play the audible announcement to the destination telephone over the three-party call. Other types of ancillary communication paths and/or identification signals may be used within the scope of the invention.

While embodiments have been described primarily in the context of telephony communications, including circuit-switched telephony applications over public switched telephone networks, wireless telephone networks and other circuit-switched networks, as well as telephony applications over packet-switched networks, such as VoIP networks, it will be appreciated that the invention is not limited thereto, and can be applied to many other different types of communications, communication networks and/or communication devices, including other types of analog and/or digital voice and/or data communications, communication networks and/or communication devices.

In the drawings and specification, there have been disclosed typical embodiments and, although specific terms are employed, they are used in a generic and descriptive sense only and not for purposes of limitation, the scope of the invention being set forth in the following claims.

What is claimed is:

1. A method of re-forwarding a forwarded communication to a destination communication device, comprising:
receiving the forwarded communication at a communication port;
re-forwarding the forwarded communication from the communication port to the destination communication device;
generating an identification signal based on an identity of the communication port; and
transmitting the identification signal to a user of the destination communication device.

2. The method of claim 1, wherein the identification signal describes a forwarding communication device from which the forwarded communication was initially forwarded to the communication port.

3. The method of claim 2, further comprising retrieving a database entry corresponding to the communications port and obtaining from the database entry a description of the communication device from which the communication was initially forwarded.

4. The method of claim 2, wherein the identification signal includes a telephone number, SIP address and/or name of the communication device from which the communication was initially forwarded.

5. The method of claim 2, wherein the identification signal identifies a class of communication devices that includes the the communication device from which the communication was initially forwarded.

6. The method of claim 1, wherein the communication is received at a forwarding agent, the method further comprising establishing an ancillary communication path between the forwarding agent and the user of the destination communication device, and wherein transmitting the identification signal to the user of the destination communication device comprises transmitting the identification signal over the ancillary communication path.

7. The method of claim 6, wherein the ancillary communication path is established between the forwarding agent and the destination communication device.

8. The method of claim 6, wherein the ancillary communication path comprises a short message service (SMS) connection.

9. The method of claim 6, wherein the ancillary communication path comprises an in-band or out-of-band signaling path to the destination communication device.

10. The method of claim 6, wherein the ancillary communication path comprises an on-hook signaling path to the destination communication device.

11. The method of claim 6, wherein the identification signal comprises an audible announcement to the destination communication device.

12. The method of claim 11, wherein establishing the ancillary communication path comprises establishing a three-party call with an original calling party and the destination communication device, and wherein transmitting the identification signal comprises playing the audible announcement to the destination communication device over the three-party call.

13. The method of claim 6, wherein the ancillary communication path comprises a session initiation protocol (SIP) session.

14. The method of claim 1, wherein the identification signal comprises a distinctive ring signal provided to the destination communication device.

15. A forwarding agent comprising a plurality of incoming communication ports, wherein the forwarding agent is configured to receive a forwarded communication at an incoming communication port, to re-forward the forwarded communication to a destination communication device, to generate an identification signal based on the incoming communication port, and to transmit the identification signal to a user of the destination communication device.

16. The forwarding agent of claim 15, wherein the forwarding agent is further configured to establish an ancillary communication path to the user of the destination communication device, and to transmit the identification signal over the ancillary communication path.

17. The forwarding agent of claim 15, wherein the ancillary communication path comprises a short message service (SMS) connection and/or a session initiation protocol (SIP) session.

18. The forwarding agent of claim 15, wherein the ancillary communication path comprises an audible signal path to the destination communication device.

19. The forwarding agent of claim 15, wherein the ancillary communication path comprises a three-party call with an original calling party and the destination communication device, and wherein the forwarding agent is configured to play an audible announcement to the destination communication device over the three-party call.

20. A computer program product for re-forwarding a forwarded communication to a destination communication device, the computer program product comprising:
a computer readable storage medium having computer readable program code embodied in the medium, the computer readable program code comprising:
computer readable program code configured to receive the forwarded communication at a communication port;
computer readable program code configured to re-forward the forwarded communication from the communication port to the destination communication device;
computer readable program code configured to generate an identification signal based on an identity of the communication port; and
computer readable program code configured to transmit the identification signal to a user of the destination communication device.
